(19) United States
(12) Patent Application Publication
(10) Pub. No.: US 2011/0158788 A1
(43) Pub. Date: Jun. 30, 2011

(54) A SECTIONAL BLADE

(75) Inventors: Anton Bech, Ringkobing (DK); Paul Hibbard, Singapore (SG)

(73) Assignee: VESTAS WIND SYSTEMS A/S, Randers SV (DK)

(21) Appl. No.: 13/060,744

(22) PCT Filed: Aug. 31, 2009
(86) PCT No.: PCT/EP2009/061180

§ 371 Date: Mar. 14, 2011

Related U.S. Application Data
(60) Provisional application No. 61/095,011, filed on Sep. 8, 2008.

(30) Foreign Application Priority Data
Aug. 31, 2008 (DK) PA 2008 01208

(51) Int. Cl. F04D 27/02; F03D 11/00; B23P 15/02

(52) U.S. Cl. 415/1; 416/226; 29/889.7

(57) ABSTRACT

The invention provides a sectional blade for a wind turbine. The blade comprises at least a first blade portion and a second blade portion extending in opposite directions from a joint. The first blade portion and the second blade portion are structurally connected by at least one spar bridge extending into both blade portions to facilitate joining of said blade portions.

### TECHNICAL FIELD

The present invention relates to a sectional blade for a wind turbine, the blade comprising at least a first and a second blade portion extending in opposite directions from a joint.

### BACKGROUND OF THE INVENTION

Modern wind turbines comprise a plurality of wind turbine rotor blades, typically three blades, each blade today having a weight of up to 15 tons and a length of up to 55 meters.

Traditionally, a blade comprises two shell parts, one defining a windward side shell part and the other one defining a leeward side shell part. Each of the shell parts are traditionally made in one piece. To reinforce such a blade a box-shaped, longitudinal and tubular element, i.e. a spar, can act as a reinforcing beam. The spar is located in the cavity between the two wind turbine shell parts and extends substantially throughout the shell cavity in order to increase the strength and stiffness of the wind turbine blade.

As the size of wind turbines and thus wind turbine blades are still growing, the production facilities and the transport means must be increased to handle blades of the required size. This also increases the demand on logistics and increases the associated costs.

### SUMMARY OF THE INVENTION

It is an object of embodiments of the present invention to provide an improved wind turbine blade comprising at least two portions and to provide an improved method of manufacturing such a blade.

In a first aspect, the present invention relates to a sectional blade for a wind turbine, the blade comprising at least a first blade section and a second blade section extending in opposite directions from a joint, wherein the first blade section and the second blade section are structurally connected by at least two spar bridges extending into both blade sections so as to facilitate joining of the two blade sections.

In one embodiment, the joint between the two blade portions may be transverse to the length of the blade, thus allowing for a blade comprising smaller sections compared to a traditional blade being manufactured of shell parts of full-size.

Hence, the blade is easily transported from a manufacturing site to an assembly site at which it is assembled, compared with large blade shells or complete blades. Moreover, the blade portions may be smaller than normal blade shells. Furthermore, the assembly site can be situated close to the place where the turbine blade it to be used.

By manufacturing the blade of different parts, these parts may be transported unassembled, thereby facilitating transport with the possibility of reducing the associated costs.

The joint may be located approximately at the centre of the blade providing blade portions of approximately the same length. However, the blade portions may also be of different length. As an example, the first blade portion may define a main blade portion, whereas the second blade portion may define a tip portion.

Furthermore, the blade may comprise more than one joint and thus comprise more than two blade portions and more than one spar bridge.

In the context of the present invention the term “spar bridge” shall be understood as a member extending between two neighboring blade portions which member serves the function of interconnecting the two blade portions and which serves the purpose of joining the two portions. The spar bridge may be a separate member or may form an integral part of or be fastened to one of the two neighboring blade sections.

Each blade portion may comprise two shell parts, one defining a windward side shell part and the other one defining a leeward side shell part. These shell parts may be assembled before joining the first and second blade portions.

When assembled, the first blade portion and the second blade portion are structurally connected by at least two spar bridges extending into both blade portions to facilitate joining of said blade portions.

The spar bridge may be a longitudinal element which may be box-shaped, cylindrical, or of any other shape. The cross-sectional shape of the spar bridge in a direction transverse to the spar bridge and/or the sectional blade may be circular or polygonal such as triangular or quadrangular.

The spar bridge may form part of the longitudinal strength of the wind turbine blade, thus being part of the reinforcement of the blade.

Furthermore, the spar bridge may be a solid, a partly solid, or a tubular element. In the context of the present invention, the term “tubular element” shall be understood as a hollow element with an elongated shape. The cross-sectional shape of one of the spar bridges may be non-uniform e.g. defining only one or even no line of symmetry. The outer geometry may be of a rectangular shape, a partly circular shape, an oval shape or any other shape. The inner geometry may be different from the outer shape, thus defining a tubular element in the form of an elongated ring of an arbitrary shape.

In one embodiment, one or more of the spar bridges forms part of the first blade section. Moreover, the second blade section may define one or more spar sections each of which is adapted to receive one of the spar bridges so as to secure the spar bridge to the spar section. In one embodiment, any of the spar bridges forms an integral part of the first blade section. At the same time, the second blade section may define a corresponding number of spar sections for receiving the spar bridges of the first blade section.

In one embodiment a first plurality of spar bridges forms part of the first blade section and a second plurality of spar bridges forms part of the second blade section. In the latter embodiment, the first and the second blade sections may define a corresponding number of spar sections, i.e. the number of spar sections defined by the first blade section is equal to the number of spar bridges defined by the second blade section, and vice versa.

In one embodiment, the spar bridges and the spar sections of one of the blade sections are provided next to each other such that every second of the bridges/sections is a spar bridge and every other is a spar section. In the latter embodiment, any spar bridge is neighbored by one or two spar sections, and vice versa. It will be appreciated that in the latter pattern only the end spar bridge/section is neighbored by one of the opposite kind, while all the remaining bridges/sections are each neighbored by two of the opposite kind.

The skilled person will readily realize that one advantage of providing first and second blade sections both of which comprise spar bridges (and corresponding spar sections) is that the stiffness of the sectional blade is increased.

However, it may also be desirable that some or all of the spar bridges forms separate elements. Accordingly, each of the first and the second blade section may define one or more spar sections each of which is adapted to receive one of the spar bridges so as to secure the spar bridge to the spar sections. It will be appreciated that one advantage of providing the spar bridges as separate elements is that the blade sections may be shorter which may be an advantage during transport of the blade. Another advantage is that the spar bridges do not define an exposed end part of the blade sections during transport. Such exposed end part position may be subject to unintended impact during transport.

One or more of the spar sections may define a longitudinally extending cavity, and at least one of the spar bridges may extend into the cavity of a spar section whereby the spar section receives the spar bridge. The cavity may extend in the longitudinal direction of the blade section. In one embodiment, the cavity extends along the entire length of the blade section, whereas the cavity in other embodiments only extends through a part of the blade section. The cavity may extend from the area of the joint and into the blade section, such as half way into the blade section, such as a third of the way into the blade section, such as a quarter of the way into the blade section. The cavity may define one or more engagement zones which is/are adapted to engage corresponding engagement zones of the spar bridge. It will be appreciated that the larger the area of the engagement zone(s) is, the larger the force applied to tension the two blade sections towards each other may be. In one embodiment, the entire inner surface of the cavity defines an engagement zone.

In one embodiment only one spar bridge extends into each spar section, whereas in other embodiments at least one of the cavities is adapted to receive a plurality of spar bridges.

In an alternative embodiment, some or all of the spar bridges are not inserted into a cavity of a spar section. Instead one or more of the spar sections receives one of the spar bridges such that an outer surface of the respective spar bridge engage an outer surface of the respective spar section. In the latter embodiment, the spar bridge and the spar section may be provided next to each other whereby the engagement of the two is achieved. In one embodiment, at least one of the spar bridges abuts (by engagement of outer surfaces) the outer surface of at least two spar sections. In an alternative embodiment, at least one of the spar sections abuts (by engagement of outer surfaces) the outer surface of at least two spar bridges.

In the context of the present invention the term “longitudinal direction” of the sectional blade shall designate the direction generally extending from the tip of the blade to the root of the blade, the root being the area which is attached to the wind turbine.

In one embodiment, the spar bridges extend in a longitudinal direction of the sectional blade. Moreover, one or more fastening elements may be provided each of which is adapted to fasten the spar bridges to the spar sections by extending through both the spar bridges and the spar sections in a direction transverse to the longitudinal direction of the sectional blade. Each fastening elements may be an elongated element with a cross-section which is substantially identical to fastening passages defined in the spar bridges and the spar sections. The cross-sectional shape of the fastening elements may be circular or polygonal such as triangular or quadrangular. The outer surface of the fastening elements may be adapted to abut the inner surfaces of the fastening passages when inserted therein.

Alternatively, or as a supplement, one or more torsion members may be arranged to provide tension between the first blade section and the second blade section. In one embodiment, the tension members are separate elements which are used to fasten the first and the second blade section to each other. In one embodiment, the tension members define a threaded outer surface which is adapted to be threadedly received in internally threaded indentations defined in the first and second blade section. Centrally on the threaded tension member, a nut may be provided so as to allow the tension member to be screwed into the first and second blade section by turning the nut. It will be appreciated that in order to cause the tension member to be simultaneously screwed into both blade sections while rotating the nut in one direction, the thread outer surface at one end of the tension member must be a left threaded while the other is right threaded. It will be appreciated that in order to be able to access the nut, when the blade sections are fastened to each other, the sectional blade may comprise a detachably attached hatch.

In one embodiment, each of the spar bridges and/or the spar sections defines at least two caps which are interconnected by one or more webs.

In the context of the present invention, the term “caps” shall designate parts of the spar bridges and spar sections that define a plane which is parallel with a tangent to the windward or leeward side of the blade.

In the context of the present invention, the term “webs” shall designate parts of the spar bridges and spar sections which extend in a direction transverse to the windward or leeward side of the blade.

The cabs and the webs may be arranged with respect to each other such that they define a substantially right angle relative to each other. In one embodiment one or more of the previously mentioned cavities are defined by two caps and two webs.

One or more of the spar sections may be integrated into one element, e.g. defining two cavities. In the latter embodiment, at least one of the webs defines a sidewall of two neighboring cavities, whereby the spar section in this embodiment may comprise two cabs interconnected by three webs which are spaced apart so as to define the two cavities.

Alternatively, each of the spar bridges may define an I-structure defined by two cabs interconnected by a web. The web may extend from a central position of each of the two cabs. In order to increase the strength of the I-structure, the cabs and/or the web of the I-structure may comprise a plurality of reinforcing layers. Such layers may be a fibrous material such as fiber glass material or Kevlar. The layers may be provided so as to strengthen the I-structure in a predetermined direction. As an example, the layers may be provided on the upper surface of the cabs and/or on a lateral surface of the web. In the case of the web, lateral surfaces shall designate the side surfaces extending between the caps on opposite sides of the web.

In order to facilitate a light and strong material, the webs and/or the caps may comprise a composite structure. In one embodiment, the reinforcing layers define the outer surfaces of the composite structure.

In order to allow the previously mentioned fastening elements to extend through the spar bridges and the spar sections, fastening passages for receiving the fastening elements may be defined in the webs. It will be appreciated that in order to be able to transfer a tensioning force from the fastening elements to the webs, it is desirable that the webs comprises means for such transfer of the forces. Accordingly, each of the spar bridges and each of the spar sections may comprises fastening zones each defining one fastening passage, and each being sufficiently wide to cause the fastening zones of two neighboring spar bridges and/or spar sections to abut each other.

In one embodiment, the fastening zones extend in a lateral direction from one or both the lateral sides of the web. The width of the fastening zones (i.e. the distance from the most lateral surface of the fastening zone to the lateral side surface of the web) may be identical for both the fastening zones.

Alternatively, the width of a first fastening zone extending from a first of the lateral side surfaces may be different from the width of a second fastening zone extending from a second of the lateral side surfaces of the same web. In one embodiment, the first fastening zone is 20 percent wider than the second fastening zone, such as 40 percent wider, such as 80 percent wider, such as 100 or 150 percent. However, in order to allow two neighboring fastening zones of two neighboring spar bridges/sections to abut each other, it will be appreciated, that the sum of the width of the two fastening zones may not be larger than the distance between the lateral surfaces facing each other.

Moreover, the fastening zones may be sufficiently rigid to allow each of the fastening elements to tension the fastening zones through which it extends towards each other, while causing the spar bridges and/or spar sections to bent insignificantly in the direction of the fastening elements. In this context the term insignificantly may be understood such that any bending of the spar bridge/section will not cause the spar bridges/sections to break.

As mentioned previously, one or more tension members may be provided for tensioning the first and second blade sections towards each other. One reason for doing this is to prevent that the tip part of the first and the second blade sections is loosened relative to the other of the two blade sections. Another reason for doing this is to reduce or eliminate the risk of one of the two blade sections bending relative to the other. In order to reduce the risk even further, the spar bridges may define tapered end zones which are adapted to be received in corresponding tapered indentations of the blade sections. It will be appreciated that forcing such tapered end zones and tapered indentations towards each other will cause the spar bridge and the blade sections to be keyed together even more.

In one embodiment, the tapered end zones and the tapered indentations define tapered surfaces which define a plane extending through a windward side and the leeward side of the blade. In the latter case, the caps will converge towards the tip of the spar bridge. Alternatively, or as a supplement, the tapered end zones and the tapered indentations may define tapered surfaces which define a plane extending through a leading edge and the trailing edge of the sectional blade. In the latter case the webs will converge towards the tip of the spar bridge. The converging planes of the tapered end zones may define an angle in the range of 5 to 25 degrees, such as in the range of 10 to 20 degrees.

In a second aspect, the present invention relates to a method of manufacturing a sectional blade according to the first aspect of the invention, the method comprising the steps of:
providing a first blade portion and a second blade portion;
arranging the blade portions so that they extend in opposite directions from a joint; and
structurally connecting the blade portions by use of at least two spar bridges.

It will be appreciated that the invention according to the second aspect may comprise any combination of features and elements of the invention according to the first aspect.

In a third aspect, the present invention relates to a wind turbine comprising a sectional blade according to the first aspect of the invention.

It should be understood, that the features of the first and second aspects previously described may also be applicable to the third aspect of the invention.

The wind turbine may comprise a control system connected to a sensing structure for sensing a tension in a tension member arranged to provide tension between the first blade portion and the second blade portion to establish a pre-tensioned connection between the blade portions.

As an example, the sensing structure may comprise strain gauges or similar structures which are capable of sensing elongation of the tension member.

The sensing structure may provide the control system with information about the tension in the tension member. And the control system may be adapted to provide an alarm if the tension in the tension member is below a predetermined level.

Furthermore, the wind turbine may comprise a shut down structure adapted to stop operation of the wind turbine if the tension in the tension member is below a predetermined level. This predetermined level, i.e. a stop level, may be equivalent to the predetermined level which results in an alarm, i.e. an alarm level, but it may also be another predetermined level, as the alarm level may be different than the stop level, e.g. higher than the stop level.

In a fourth aspect, the invention provides a method of operating a wind turbine according to the third aspect of the invention, the method comprising a step of determining a tension in a tension member arranged to provide tension between the first blade portion and the second blade portion to establish a pre-tensioned connection between the blade portions.

It should be understood, that the features of the above-described first and second aspects of the invention may also be applicable in relation to steps of the fourth aspect of the invention.

The method may comprise a step of adjusting the tension in the tension member if the determined tension is outside a predetermined tension range. As both a too high tension level and a too low tension level may be unwanted, the predetermined tension range may comprise an upper and a lower level for the tension.

The method may further comprise a step of stopping further operation of the wind turbine if the tension in the tension member is below a predetermined level. Operation below this predetermined level may be dangerous, as a too low tension level may in the extreme situation result in separation of the first and second blade portions.

### BRIEF DESCRIPTION OF THE DRAWINGS

FIGS. 1 and 2 disclose an isometric view and a cross-section view, respectively, of a first embodiment of the present invention,

FIGS. 3 and 4 disclose an isometric view and a cross-section view, respectively, of a second embodiment of the present invention,

FIG. 5 disclose a front elevational view of a third embodiment of the present invention,

FIG. 6 discloses an isometric view of the third embodiment,

FIG. 7 discloses a cross-sectional view of the third embodiment

FIG. 8 discloses an isometric view of the spar bridges of the third embodiment,

FIG. 9 discloses a cross-sectional view of the spar bridges and the spar sections of the third embodiment,

FIGS. 10 and 11 disclose a tension member of the third embodiment,

FIGS. 12-14 disclose alternative ways of securing the spar bridges to the spar sections,

FIG. 15 discloses an isometric view of a fourth embodiment of the invention,

FIGS. 16-17 disclose a cross-sectional view and an isometric view, respectively, of an engagement ring of the fourth embodiment,

FIG. 18 discloses an isometric view of a spar bridge of the fourth embodiment,

FIG. 19 discloses a cross-sectional view of the spar bridge of the fourth embodiment,

FIG. 20 discloses an isometric view of alternative to the fourth embodiment,

FIG. 21 discloses an isometric view of a fifth embodiment of the present invention,

FIG. 22 discloses an isometric view of a sixth embodiment of the present invention,

FIG. 23 discloses a cross-sectional view of a seventh embodiment of the invention,

FIG. 24 discloses an isometric view of the seventh embodiment,

FIG. 25 discloses a top elevational view of the seventh embodiment,

FIG. 26 discloses cross-sectional view of a spar bridge,

FIG. 27 discloses an isometric view of an eighth embodiment of the invention,

FIG. 28 discloses an isometric view and cross-sections thereof of a ninth embodiment,

FIG. 29 discloses an isometric view of the ninth embodiment, and

FIG. 30 discloses a cross-sectional view of the ninth embodiment.

### DETAILED DESCRIPTION OF THE DRAWINGS

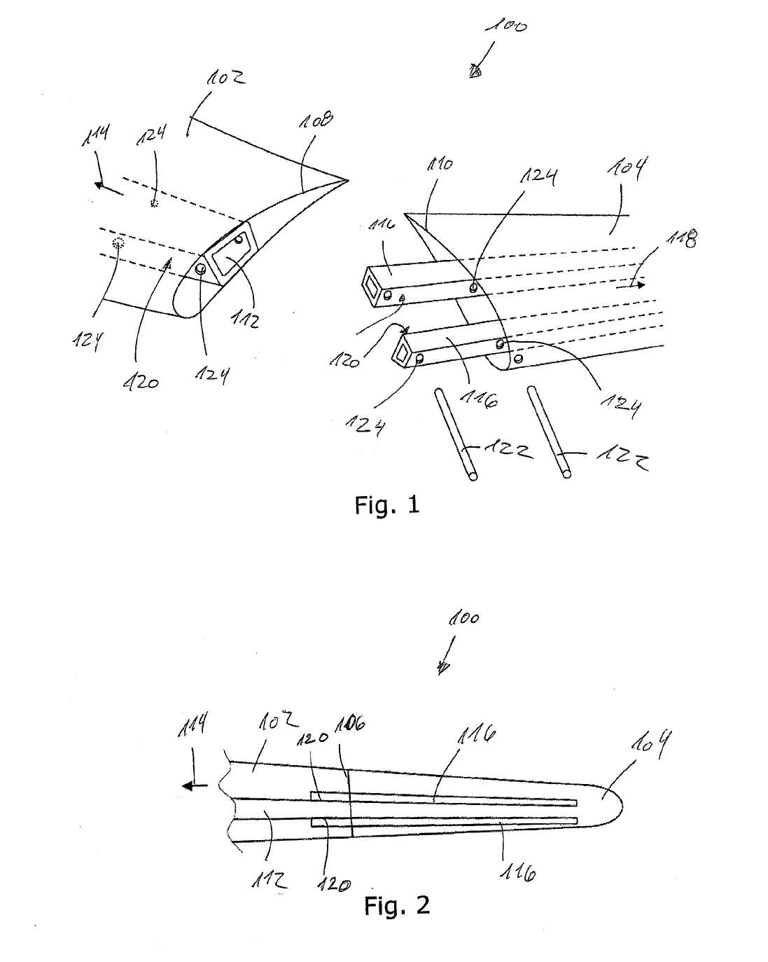

FIGS. 1 and 2 disclose a first embodiment of a sectional blade 100 comprising a first blade section 102 and a second blade section 104. In FIG. 1 the blade sections 102,104 are not assembled, whereas the blade sections 102,104 are assembled in FIG. 2. When the blade sections 102,104 are assembled, the blade sections extend in opposite directions from a joint 106 as may be seen in FIG. 2. The first blade section 102 and the second blade section 104 comprise a first joint surface 108 and a second joint surface 110, respectively, which abut each other when the sectional blade 100 is assembled.

The first blade section 102 comprises one spar section 112 which extends in the longitudinal direction of the first blade section 102 i.e. towards the root, which is not illustrated, but the position of which is indicated by arrow 114.

The second blade section 104 comprises two spar bridges 116 which extend in the longitudinal direction of the second blade section 104 i.e. towards the blade tip, which is not illustrated but the position of which is indicated by arrow 118. Moreover, the two spar bridges 116 extend in a direction away from the second joint surface 110 so as to allow them to be inserted into the first blade section 102 as illustrated in FIG. 2. When the two spar bridges 116 are inserted into the first blade section 102, engagement zones 120 on the outer surfaces of the spar section 112 and the spar bridges 116 abut/engage each other, see FIG. 2. Due to the abutment, the stiffness of the sectional blade 100 is increased.

The spar section 112 and the spar bridges 116 are secured to each other by means of fastening elements 122 which are inserted into fastening passages 124 of the spar section 112 and the spar bridges 116 whereby the fastening elements 122 extend in a direction transverse to the longitudinal direction of the sectional blade 100. The outer surface of the fastening means may be threaded so as to allow a fastening nut (not illustrated) to be screwed onto the fastening elements whereby spar bridges 116 and the spar section 112 may be forced together in the in the direction transverse to the longitudinal direction.

In the embodiment of FIG. 1, two fastening elements 122 are provided, but it will be appreciated that the larger the number of such elements 122 is the more stabile may the interconnection between the two blade sections 102,104 be.

In relation to the drawing in general, it should be noted that identical reference numbers refer to identical elements/features.

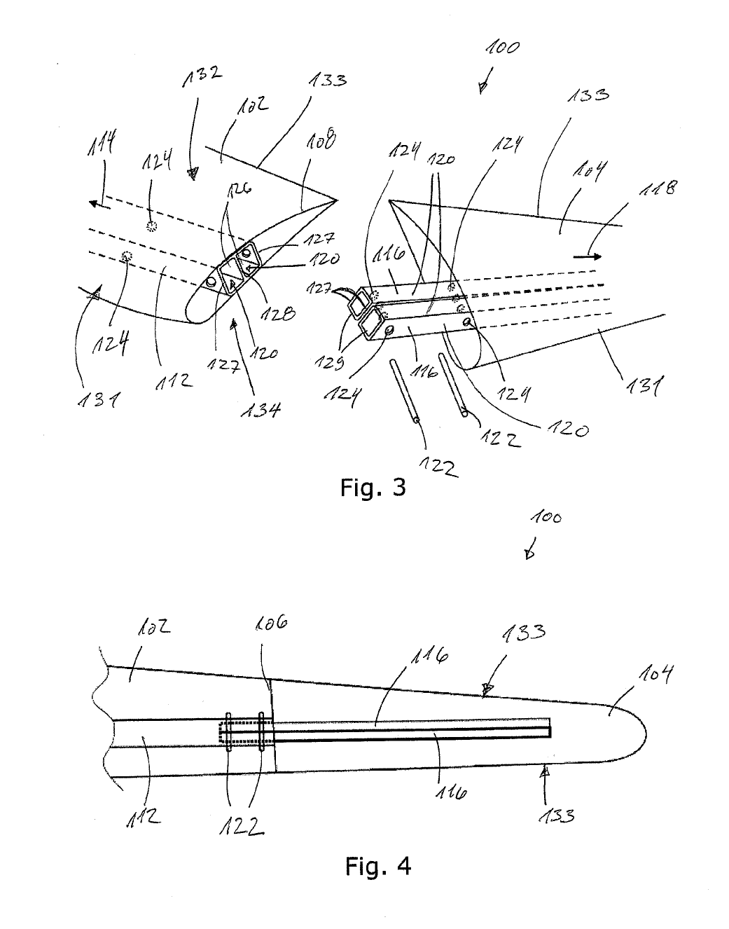

FIGS. 3 and 4 disclose a second embodiment of the sectional blade 100. The difference relative to the first embodiment is that the spar bridges 116 are received in cavities 126 of the spar sections 112. Accordingly, the engagement zones 120 of the spar sections 112 are defined on the inner surfaces of the cavities 126, while the engagement zones 120 of the spar bridges 116 are defined on the outer surfaces thereof.

In the embodiment of FIGS. 3 and 4, the first blade section 102 comprises two spar sections 112 which are interconnected by the same sidewall 128. As previously mentioned each of the spar sections 112 and each of the spar bridges 116 comprise webs 127 and caps 129. The webs 127 extend in a direction from the windward 132 to the leeward side 134 of the blade, whereby the sidewall 128 is a web. The cabs extend in a direction from the leading edge, to the training edge, of the blade. As in the case of the first embodiment, the spar bridges 116 and the spar sections 112 are fastened to each other by means of a fastening element 122 which extends in a direction from the leading edge to the trailing edge of the blade i.e. a direction transverse to the longitudinal direction of the blade.

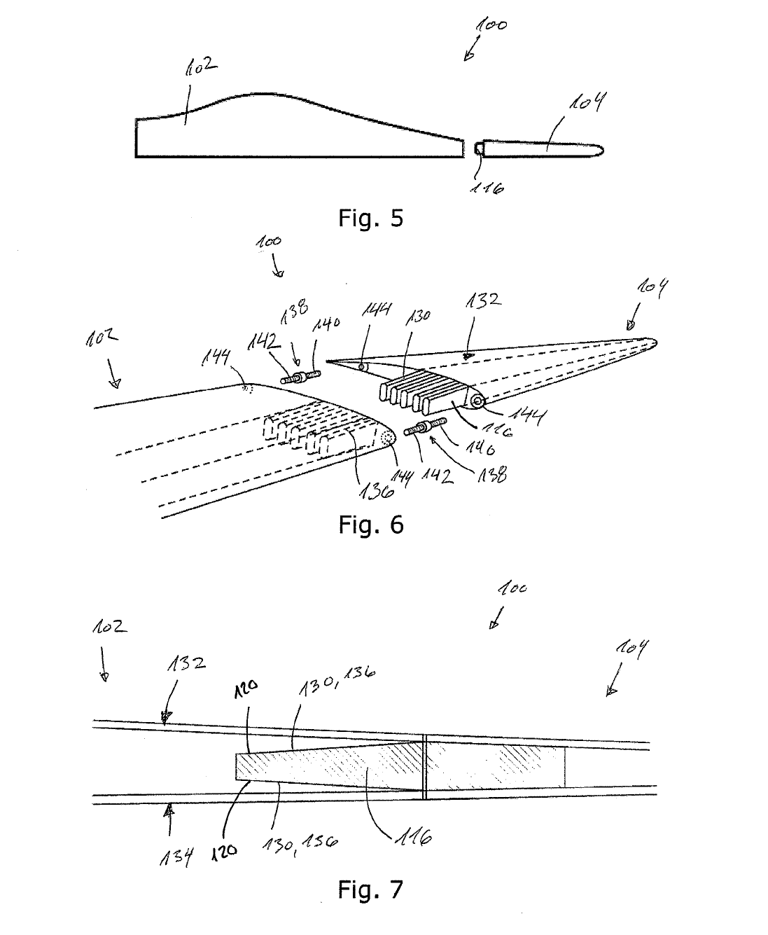

FIGS. 5-11 disclose a third embodiment of the sectional blade 100.

In FIG. 5, the sectional blade 100 and its first and second blade sections 102,104 are illustrated in a state wherein the two blade sections 102,104 are not assembled.

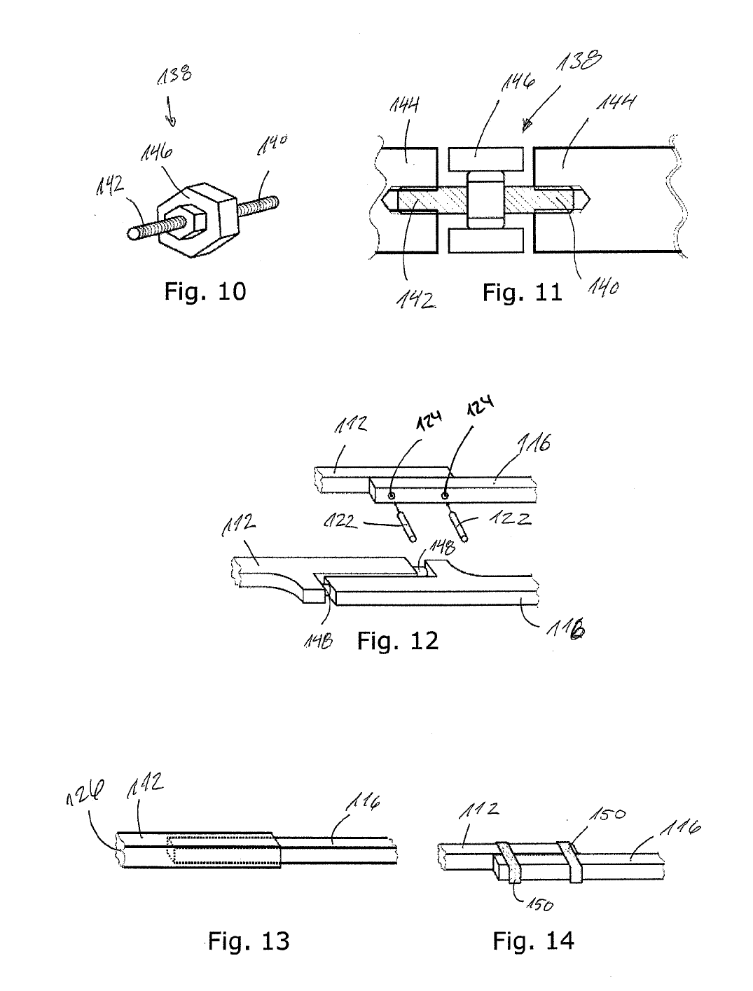

The spar bridges 116 of the third embodiment define tapered surfaces 130, which each defines a plane (not illustrated) that extend through a windward side 132 and the leeward side 134 of the blade. Similarly, the spar sections 106 define tapered inner surfaces 136 which each defines a plane (not illustrated) that extend through the windward side 132 and the leeward side 134 of the blade. When the spar bridges 116 are inserted into the spar sections 112 as illustrated in FIG. 7, the tapered surfaces 130,136 are brought into engagement with each other and thus define the engagement zones 120 of the tapered surfaces 130,136. It will be appreciated that the tapered surfaces 130,136 of the spar sections 112 and the spar bridges 116 should be tapered by the same angle so as to increase the area of engagement between the tapered surfaces 130,136. In order to tension the spar bridges 116 and the spar sections 112 towards each other, tension members 138 are provided. In the third embodiment, the tension members 138 are rod shaped with a threaded outer surface. A first part of the threaded surface is a left thread 140 whereas a second part is a right thread 142. By providing two different kinds of threads rotation of the tension member 138 causes it to be screwed into or out of both the blade sections, 102,104 simultaneously. In order to receive the threaded outer surface, the blade sections 102,104 comprise internally threaded indentations 144. In order to facilitate rotation of the tension members 138, each of the members comprises a nut 146 (visible in FIGS. 10 and 11) which defines a hexagonal outer surface. It will be appreciated that the nut 146 may be engaged by means of any conventional tool for spanning a nut. Moreover, it will be appreciated that the blade sections may comprise a hatch (not shown) for accessing the nut during assembly or disassembly of the blade sections 102,104.

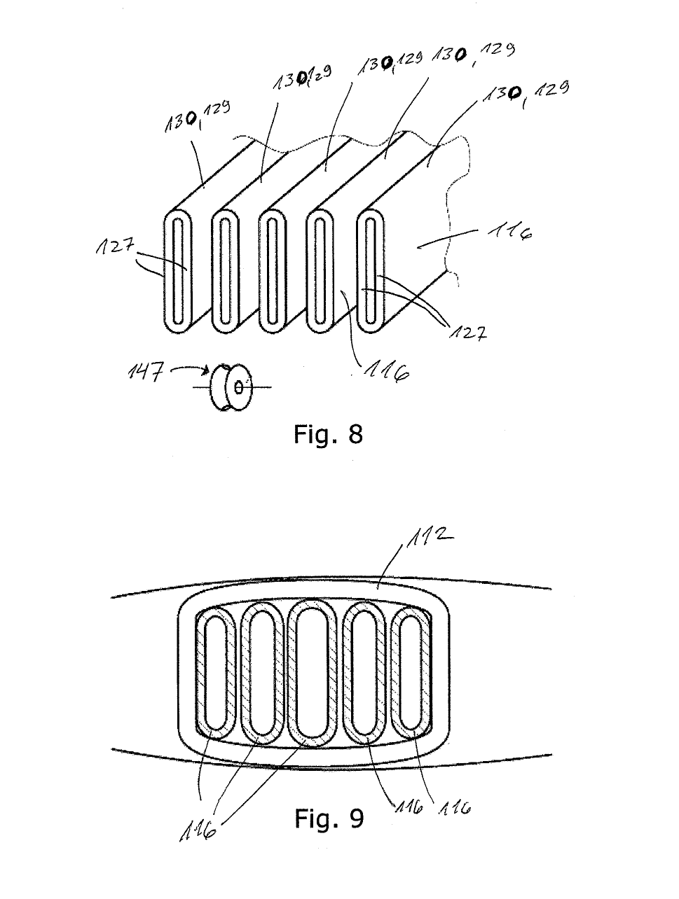

FIG. 8 discloses an example of spar bridges 116 with tapered surfaces 130. The transitions between the caps 129 and the webs 127 are rounded by means of rounding tool 147.

In the embodiment of FIG. 9, one spar section 112 is adapted to receive a plurality (five in the case of the figure) of spar bridges 116. Due to the rounded caps 129, the loads are taken through said rounded surfaces which engage the inner surface of the spar section 112 when the spar bridges 116 are inserted into the spar section 112.

FIGS. 12-14 disclose alternative ways of connecting a spar bridge 116 to a spar section 112. In the lower part of FIG. 12, both the spar bridge 116 and the spar section 112 comprises guiding members 148 for guiding the spar bridge 116 and the spar section 112 into engagement with each other. In order to lock the spar bridge 116 and the spar section 112 longitudinally relative to each other, a fastening element 122 may be provided which is inserted (e.g. screwed) into the fastening passages 124 as illustrated in the upper part of FIG. 12.

In FIG. 13, the spar bridge 116 is inserted into a cavity 126 of the spar section 112 as is discussed previously. In FIG. 14 the spar bridge 116 and the spar section 112 are fastened/secured to each other by means of tension bands 150.

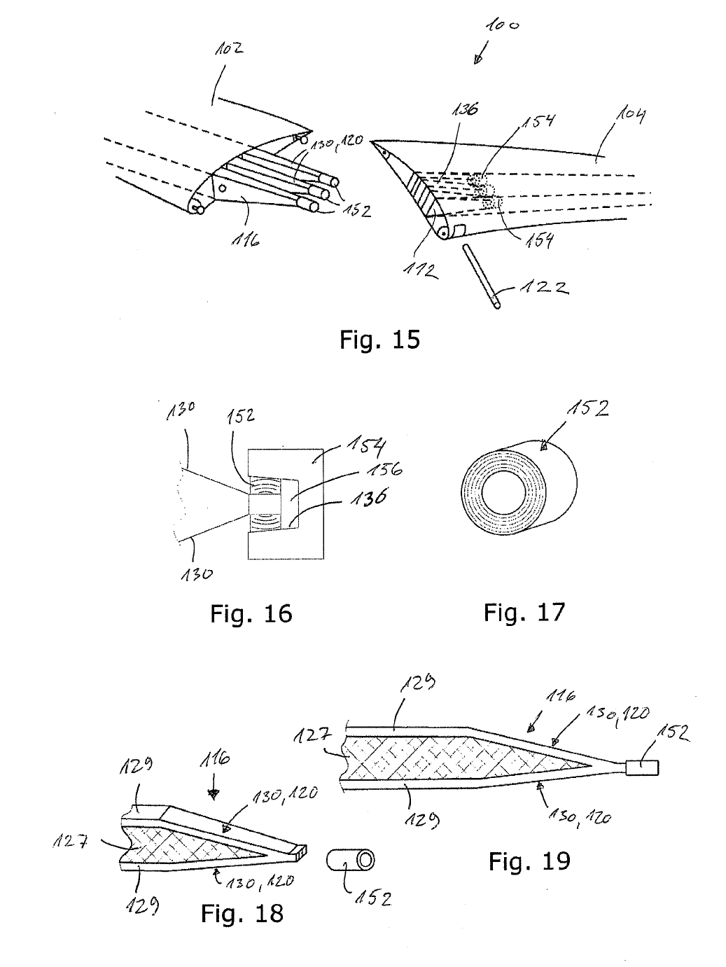

FIGS. 15-20 disclose a fourth embodiment in which the spar bridges 116 define tapered surfaces 130 which are adapted to engage corresponding tapered inner surfaces 136 of the spar sections 112. Moreover, each of the spar bridges 116 comprises an engagement ring 152, provided at the end of the respective spar bridge 116. The engagement rings 152 are each adapted to be inserted to an engagement ring receiver 154, which may comprise a tapered inner surface 136. It will be appreciated that due to the tapered surfaces movement of the engagement ring 152 into the engagement ring receiver 154 will cause the receiver 154 and the ring 152 to be locked in a direction transverse to the longitudinal direction of the blade section. This causes the two blade sections to be stabilized even further. It will be appreciated that by designing the engagement ring receiver 154 such that a space 156 is defined between the end of the engagement ring 152 and the bottom of the engagement ring receiver 154, the spar bridge 116 and the spar section 112 may move longitudinally relative to each other during use, e.g. due to changes in temperature or humidity. The engagement ring may be made from a reinforced material such as an elastomeric material comprising Kevlar or fiber glass.

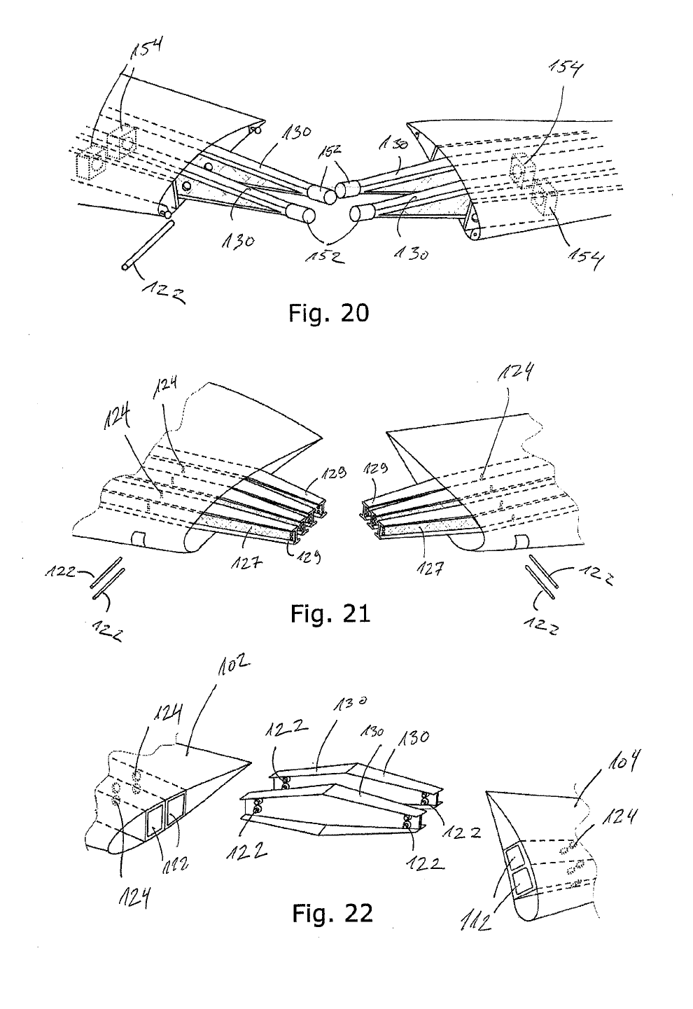

FIG. 20 shows an alternative to the embodiment of FIGS. 15-19, in which the tapered surfaces 130 of the spar bridges 116 do not serve as engagement zones 120 and do not engage corresponding engagement zones 120 of the spar sections 112. Accordingly, only the engagement rings 152 of the spar bridges engage corresponding engagement ring receivers 154 of the spar sections 112. Another difference is that each of the first and the second blade sections 102,104 comprises both spar bridges 116 and spar sections 112. The spar bridges 116 and the spar sections 112 of each of the blades sections 102,104 are arranged in the following order: spar bridge 116-spar section 112-spar bridge 116-spar section 112, i.e. none of the spar bridges 116 are arranged next to another spar bridge 116 and none of the spar sections 116 are arranged next to another spar section 112.

FIG. 21 discloses a fifth embodiment of the sectional blade of the invention. In the fifth embodiment, the spar bridges 116 are tapered such that the width of the caps 129 decrease towards the end of the spar bridge 116. Moreover, the spar bridges 116 are also tapered such that the distance between the caps 129 decreases towards the end of the spar bridge 116, whereby the height of the webs 127 decrease in the same direction.

By providing spar bridges 116 that are tapered in two directions an even further improvement of the stability of the two blades sections 102,104 may be achieved, as the lateral sides of the caps 129 may be keyed into engagement with each other.

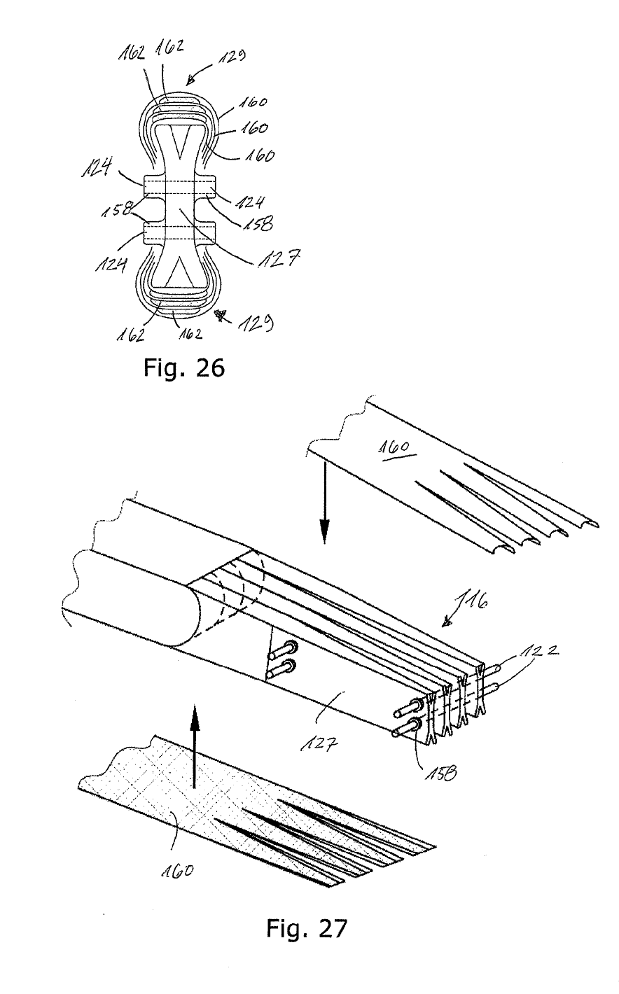

Moreover, the spar bridges 116 of the seventh embodiment define I-structures in which two caps 129 are interconnected by a web 127. The I-structures may be reinforced as is described below in relation to FIGS. 26 and 27. Two fastening elements 122 may be provided for each of the blade sections 102,104, i.e. four fastening elements 122 all in all. The fastening elements 122 are adapted to be inserted into fastening passages 124 as is described previously.

FIG. 22 discloses a sixth embodiment in which the spar bridges 116 define an I-structure with tapered surfaces 130 which are adapted to engage corresponding tapered inner surfaces of the spar section 112 of the first and the second blade section 102,104. The spar bridges of the sixth embodiment define separate elements and do not form part of the blade sections 102,104. Accordingly, a defective spar bridge may be replaced without replacing the blade sections themselves.

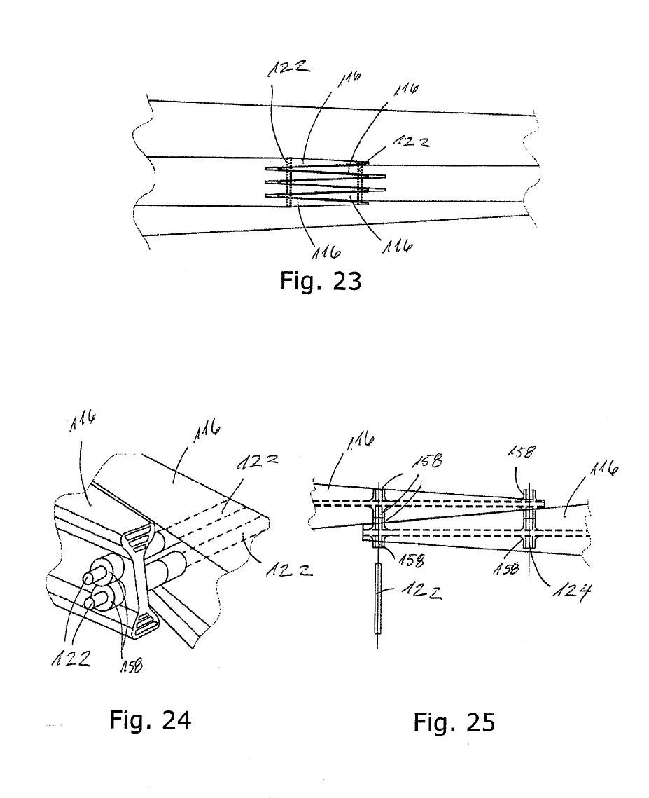

FIG. 23-25 disclose a seventh embodiment in which the spar sections are defined in the spaces between the spar bridge 116, whereby the spar bridges 116 of both blade sections are keyed into engagement with each other. The spar bridges 116 of the seventh embodiment define I-structures. In order to prevent the webs 127 of each of the spar bridges 116 from bending, when the fastening element 122 is tensioned, fastening zones 158 are provided. Each of the fastening zones 158 define a part of the fastening passage 124 and are sufficiently wide to cause the fastening zones 158 of two neighboring spar bridges 116 to abut each other when the blade sections 102,104 are assembled.

Due to the abutment between the fastening zones 158, the tension provided by the fastening elements 122 may be increased as tension will not cause the webs 127 to be damaged.

The I-structures of FIGS. 25-27 are reinforces by application of one or more reinforcing layers 160, each of which may comprise carbon fiber slabs for increasing the reinforcement provided by the layers.

FIG. 27 discloses one way of manufacturing the spar bridge 116 of FIGS. 25-27. Initially, a plurality of webs 127 is provided. The webs 127 are aligned by inserting the fastening elements 122 into the fastening passages 124 defined in the fastening zones 158. Subsequently the reinforcing layers 160 are attached to the webs 127.

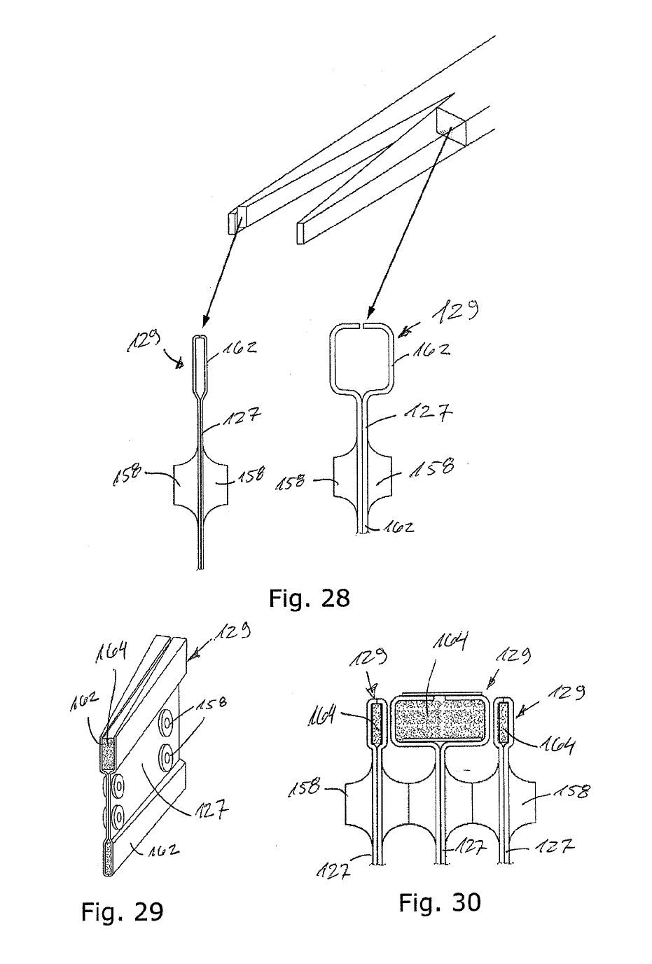

In the ninth embodiment of FIGS. 28-30 the spar bridges 116 are made of sheets 162 which are bent or cured into the desired shape such that the outer surfaces of the webs 127 and the caps 129 are defined by the sheets. Carbon fingers 164 may be provided inside the caps 129 so as to increase the strength of the caps 129. Additionally, fastening zones 158 may be defined in the sidewalls of the webs 127.

1. A sectional blade for a wind turbine, the blade comprising at least a first blade section and a second blade section extending in opposite directions from a joint, wherein the first blade section and the second blade section are structurally connected by at least two spar bridges extending into both blade sections so as to facilitate joining of the two blade sections.

2. The sectional blade according to claim 1, wherein one or more of the spar bridges forms part of the first blade section, and wherein the second blade section defines one or more spar sections each of which is adapted to receive one of the spar bridges so as to secure the spar bridge to the spar section.

3. The sectional blade according to claim 1, wherein each of the first and the second blade section defines one or more spar sections each of which is adapted to receive one of the spar bridges so as to secure the spar bridge to the spar sections.

4. The sectional blade according to claim 2, wherein one or more of the spar sections defines a longitudinally extending cavity, and wherein at least one of the spar bridges extends into the cavity of a spar section whereby the spar section receives the spar bridge.

5. The sectional blade according to claim 4, wherein one of the cavities is adapted to receive a plurality of spar bridges.

6. The sectional blade according to claim 2, wherein one or more of the spar sections receives one of the spar bridges such that an outer surface of the respective spar bridge abuts an outer surface of the respective spar section.

7. The sectional blade according to claim 2, wherein the spar bridges extend in a longitudinal direction of the sectional blade, and wherein at least one fastening element is provided each of which is adapted to fasten the spar bridges to the spar sections by extending through both the spar bridges and the spar sections in a direction transverse to the longitudinal direction of the sectional blade.

8. The sectional blade according to claim 1, wherein one or more torsion members are arranged to provide tension between the first blade section and the second blade section.

9. The sectional blade according to claim 1, wherein at least each of the spar bridges or each of the spar sections defines at least two caps which are interconnected by one or more webs.

10. The sectional blade according to claim 9, wherein one or more of the cavities are defined by two caps and two webs.

11. The sectional blade according to claim 10, wherein at least one of the webs defines a sidewall of two neighboring cavities.

12. The sectional blade according to claim 9, wherein each of the spar bridges defines an I-structure defined by two cabs interconnected by a web.

13. The sectional blade according to claim 12, wherein at least the cabs or the web of the I-structure comprises a plurality of reinforcing layers.

14. The sectional blade according to claim 9, wherein at least the webs or the caps comprise a composite structure.

15. The sectional blade according to claim 9, wherein fastening passages for receiving the fastening elements are defined in the webs.

16. The sectional blade according to claim 1, wherein each of the spar bridges and each of the spar sections comprises fastening zones each defining one fastening passage, and wherein the fastening zones are sufficiently wide to cause the fastening zones of two neighboring spar bridges and/or spar sections to abut each other.

17. The sectional blade according to claim 16, wherein the fastening zones are sufficiently rigid to allow each of the fastening elements to tension the fastening zones through which it extends towards each other, while causing the spar bridges and/or spar sections to bent insignificantly in the direction of the fastening elements.

18. The sectional blade according to claim 16, wherein the fastening zones extend laterally from opposite sides of the web of the I-structure.

19. The sectional blade according to claim 1, wherein the spar bridges define tapered end zones which are adapted to be received in corresponding tapered indentations of the blade sections.

20. The sectional blade according to claim 19, wherein the tapered end zones and the tapered indentations define tapered surfaces which define a plane extending through a windward side and the leeward side of the blade.

21. The sectional blade according to claim 19, wherein the tapered end zones and the tapered indentations define tapered surfaces which define a plane extending through a leading edge and the trailing edge of the sectional blade.

22. A method of manufacturing a sectional blade according to claim 1, the method comprising the steps of:
providing a first blade portion and a second blade portion;
arranging the blade portions so that they extend in opposite directions from a joint; and
structurally connecting the blade portions by use of at least two spar bridges.

23. A wind turbine comprising a sectional blade according to claim 1.

24. The wind turbine according to claim 23, comprising a control system connected to a sensing structure for sensing a tension in a tension member arranged to provide tension between the first blade portion and the second blade portion to establish a pre-tensioned connection between the blade portions.

25. A method of operating a wind turbine according to claim 24, comprising a step of determining a tension in a tension member arranged to provide tension between the first blade portion and the second blade portion to establish a pre-tensioned connection between the blade portions.
